(19) United States
(12) Patent Application Publication
(10) Pub. No.: US 2008/0070039 A1
(43) Pub. Date: Mar. 20, 2008

(54) In-Mold Decorated Component and Method

(76) Inventors: Robin J. Reis, West Bend, WI (US); Michael J. Ruminski, West Bend, WI (US); Jay R. Mueller, West Bend, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/684,111

(22) Filed: Mar. 9, 2007

Related U.S. Application Data
(60) Provisional application No. 60/786,344, filed on Mar. 27, 2006.

(51) Int. Cl. B32B 27/00; B32B 9/02; B32B 27/04; B29C 45/14

(52) U.S. Cl. 428/411.1; 428/473; 428/500; 264/279; 264/266

(57) ABSTRACT

An in-mold decorated component and method provides a three-dimensional elevational emblem supported on a substrate base providing a subcomponent, and a formed foundation in-molded to and supporting the subcomponent. The emblem may be partially embedded, providing a soft look and feel.

### CROSS-REFERENCE TO RELATED APPLICATION

This application claims the benefit of and priority from provisional U.S. Patent Application No. 60/786,344, filed Mar. 27, 2006.

### BACKGROUND AND SUMMARY

The invention relates to in-mold decorated components and methods.

In-mold decorated components are known in the prior art. The present invention arose during continuing development efforts directed toward improved product appearance and functionality, and manufacturing methods therefor.

### BRIEF DESCRIPTION OF THE DRAWINGS

FIG. 1 is a schematic side elevation view illustrating a subcomponent of an in-mold decorated component in accordance with the invention.

FIG. 2 is a perspective view of the subcomponent of FIG. 1.

FIG. 3 is a sectional view taken along line 3-3 of FIG. 2.

FIG. 4 is a schematic sectional view illustrating a method step in accordance with the invention.

FIG. 5 is like FIG. 4 and shows a further method step.

FIG. 6 is like FIG. 5 and shows a further method step.

FIG. 7 is a sectional view of a resulting in-mold decorated component following the method step of FIG. 6.

FIG. 8 is like FIG. 4 and shows another embodiment.

FIG. 9 is like FIG. 8 and shows a further method step.

FIG. 10 is like FIG. 9 and shows a further method step.

FIG. 11 is a side sectional view of a resulting in-mold decorated component following the method step of FIG. 10.

FIG. 12 is like FIG. 9 and shows another embodiment.

FIG. 13 is like FIG. 12 and shows a further method step.

FIG. 14 is a side sectional view showing a resulting in-mold decorated component following the method step of FIG. 13.

FIG. 15 is like FIG. 14 and shows another embodiment.

FIG. 16 is a perspective view of the in-mold decorated component of FIG. 14.

FIG. 17 is like FIG. 14 and shows another embodiment.

FIG. 18 is like FIG. 13 and shows another embodiment.

### DETAILED DESCRIPTION

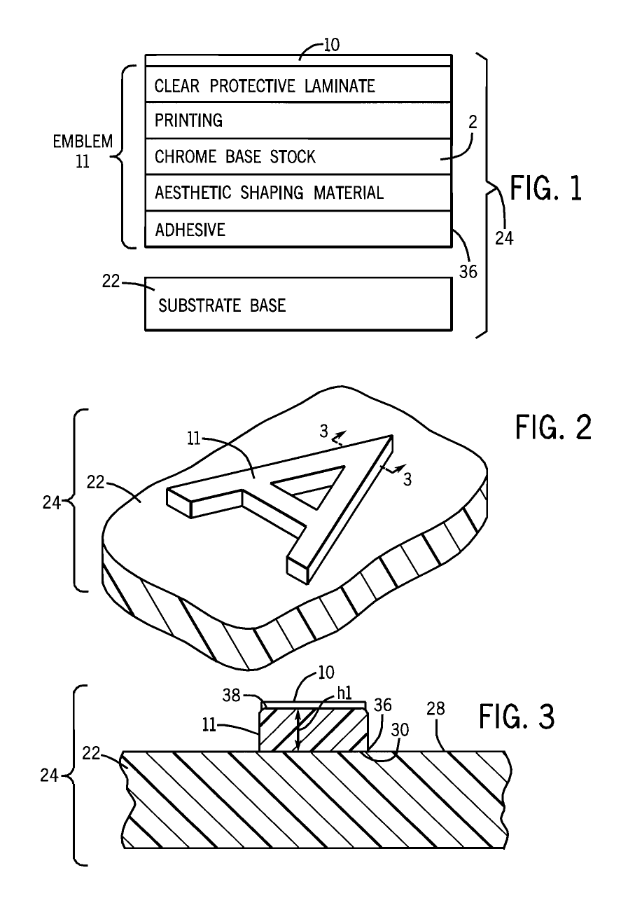

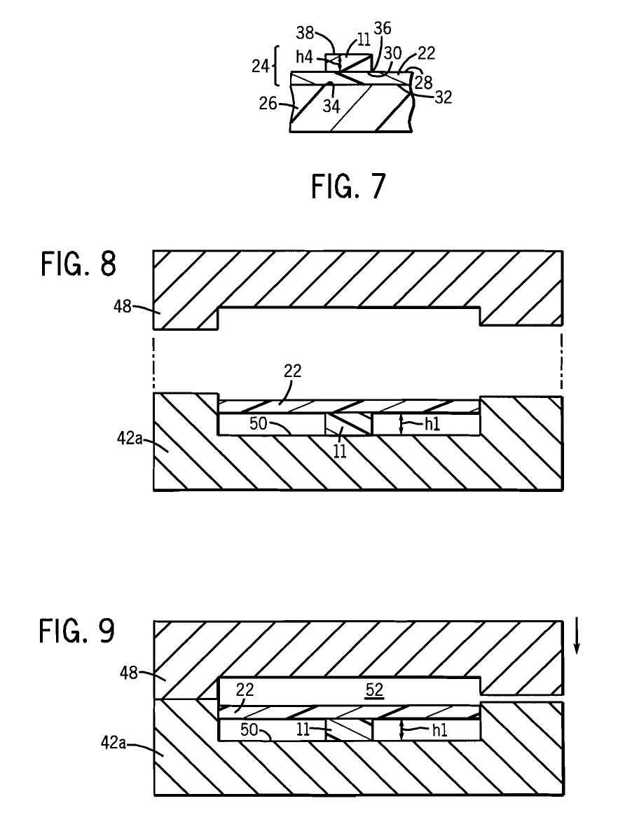

FIGS. 1-3 show a three-dimensional elevational emblem 11, e.g. in the shape of a letter “A”, and is provided by the thermoplastic resins emblem 11 shown in U.S. Pat. No. 5,589,022, incorporated herein by reference. As shown in the '022 patent, emblem 11 includes a plurality of layers or films, including a layer of adhesive, a layer of aesthetic shaping material, e.g. thermoplastic foamed PVC sheet, metallized base stock, e.g. metal vapor deposition film, if a shiny metallic appearance is desired, a printing layer as desired for color and/or graphics, and a clear protective laminate, e.g. a transparent film, as well as other layers as desired as shown in the '022 patent. A substrate base 22 supports the emblem and provides a subcomponent 24 in combination therewith. A formed foundation 26, FIGS. 7, 11, 13-17, is in-molded to and supports subcomponent 24, to be described.

Emblem 11, substrate base 22, and formed foundation 26 have first and second oppositely facing surfaces, the first surface facing the user (upwardly in FIGS. 3, 7), the second surface facing oppositely from the first surface. First surface 28 of substrate base 22 supports second surface 30 of emblem 11. Second surface 32 of substrate base 22 is in-mold bonded to first surface 34 of formed foundation 26. In the preferred embodiment, a bonding layer 36, provided by the above noted adhesive layer, bonds emblem 11 to substrate base 22 to provide the noted subcomponent 24. In one embodiment, bonding layer 36 is a pressure-sensitive adhesive layer adhesively bonding emblem 11 to substrate base 22. In another embodiment, bonding layer 36 is a heat-seal adhesive bonding emblem 11 to substrate base 22. In another embodiment, adhesive layer 36 may or may not be eliminated, and emblem 11 is sonically welded to substrate base 22. A removable heat-resistive carrier film 10 is preferably provided on first surface 38 of emblem 11, as in the '022 patent. Carrier film is between first surface 38 of emblem 11 and a mold surface 40 during in-molding of formed foundation 26, to be described.

It is preferred that subcomponent 24 is compressible, to provide a soft look and feel. In one embodiment, emblem 11 is compressible and substrate base 22 is incompressible, to be described. In such embodiment, substrate base 22 may be rigid or may be formable and bendable around emblem 11 so that the emblem is at least partially embedded in the substrate base, to be described. In another embodiment, both emblem 11 and substrate base 22 are compressible. In a yet further embodiment, each of emblem 11 and substrate base 22 are incompressible. Formed foundation 26 is preferably rigid. In some embodiments, at least of one emblem 11 and substrate base 22 includes a layer of vinyl. In other embodiments, at least one of emblem 11 and substrate base 22 includes a layer of foam plastic, leather, or simulated leather. In some embodiments, emblem 11 includes a layer 2 as in the noted '022 patent providing a bright metallic appearance, preferably a metallized layer. In some embodiments, substrate base 22 is provided by a flexible textured vinyl or cloth. In further embodiments, emblem 11 is radio frequency formed and/or cut, as in the '022 patent, prior to in-molding of formed foundation 26. In further embodiments, emblem 11 is at least partially embedded in substrate base 22, and the substrate base is a plastic sheet and is at least one of: a) formable and bendable around emblem 11; and b) compressible beneath emblem 11.

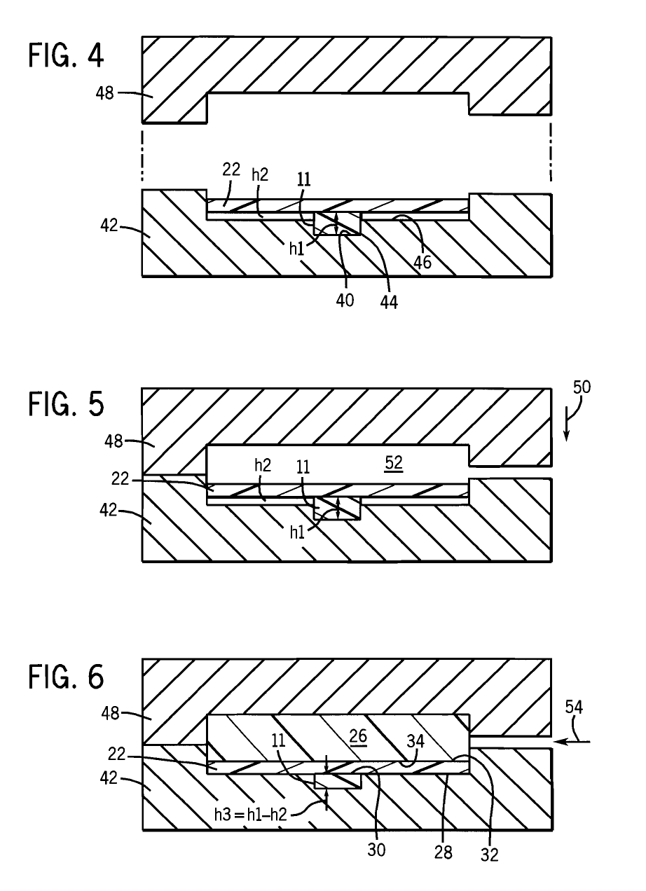

In FIGS. 4-7, subcomponent 24 of FIG. 3 is inverted and placed in a mold surface 42, with emblem 11 resting in configured mold surface or notch or groove 44, with first surface 38 of emblem 11 and carrier film 10 and engaging mold surface 40. Emblem 11 has a height h1 such that substrate base 22 is raised above the remaining mold surface 46 by a gap h2. The mold is then closed by bringing movable and stationary mold halves 48 and 42 together as shown at arrow 50, FIG. 5, followed by injection of molten plastic into mold cavity or core surfaces 52 as shown at arrow 54, FIG. 6, against second surface 32 of substrate base 22 to fuse therewith such that first surface 34 of formed foundation 26 is in-molded to second surface 32 of substrate base 22 upon hardening and cooling of the molten plastic, FIG. 7. During the injection molding, emblem 11 compresses to height h3, wherein h3=h1−h2. In this embodiment, substrate base 22 is both rigid and incompressible. After in-molding, emblem 11 may return to its initial height h1, or a lesser height h4, namely h4≦h1.

FIGS. 8-11 and 12-16 show embodiments for an in-mold decorated component wherein emblem 11 is at least partially embedded in substrate 22 to provide an embedded profile on the first surface of the component and formed against a mold surface 50 which is non-conforming to the profile, in contrast to the conformance provided by mold surface 40 at notch or groove 44 in FIG. 4 conforming to the resulting component profile, FIG. 7. The non-conformance of the profile in FIGS. 8-11 and in FIGS. 12-16 is provided by at least one of: a) compressibility of emblem 11; b) formability and bendability of substrate base 22 around emblem 11; and c) compressibility of substrate base 22 beneath emblem 11. In such embodiments, the noted profile is independent of mold geometry at mold surface 50, whereby the same mold may be used for differing emblems without having to change molds or use custom molds.

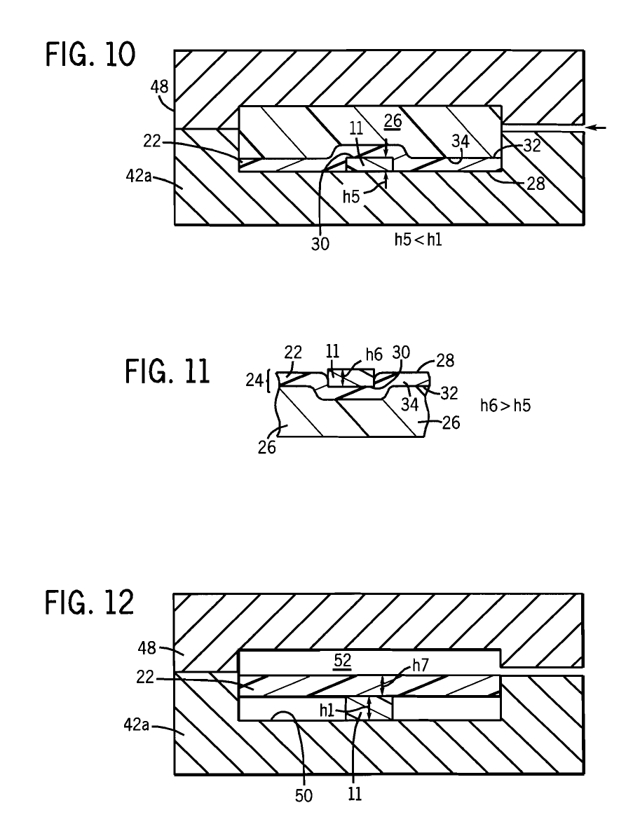

In FIGS. 8-11, substrate base 22 is incompressible but is formable and bendable around emblem 11. Subcomponent 24 of FIG. 3 is inverted and placed in a mold surface 42a, FIG. 8, followed by closing of the mold halves 48 and 42a, FIG. 9, followed by injection of molten plastic, FIG. 10. During the injection of the molten plastic, substrate base 22 forms and bends around emblem 11 as shown in FIG. 10, and emblem 11 compresses from its initial height h1 to a compressed height h5. After in-molding, emblem 11 may return to its initial height h1, or may return to a lesser height h6, where h6≧h5, FIG. 11. In other embodiments, emblem 11 may permanently compress to a new height h5, whereby the top of emblem 11 is flush with the top of substrate base 22, rather than being slightly raised thereabove as shown in FIG. 11. The slightly raised profile is preferred, i.e. h6>h5, for look and appearance.

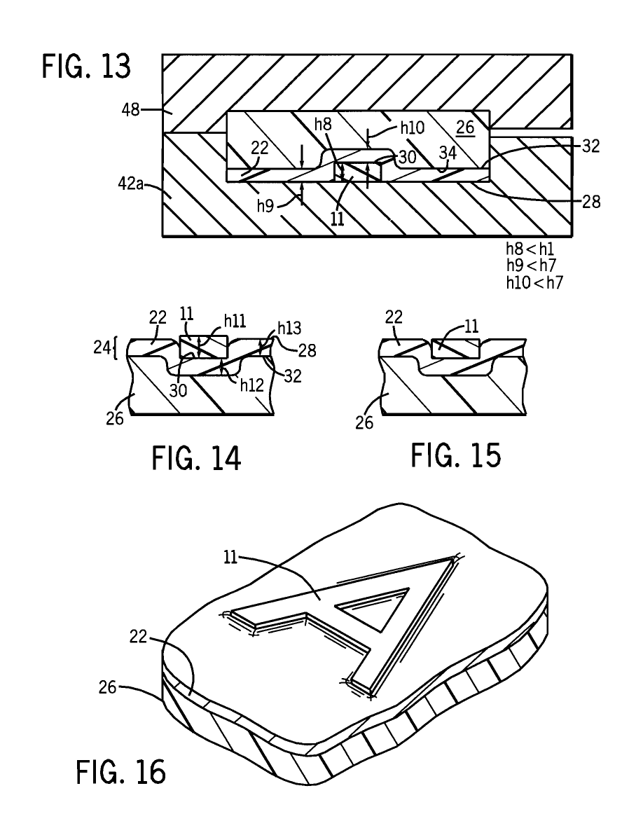

FIGS. 12-14 show an embodiment with substrate base 22 being both compressible and formable. Subcomponent 24 is inverted and placed in lower mold half 42a, followed by closing of the mold halves 48 and 42a, FIG. 12, followed by injection of molten plastic, FIG. 13. During molding, emblem 11 compresses from height h1 to height h8, and substrate base 22 compresses from initial height h7 to height h9 adjacent the emblem and compresses to height h10 in alignment with the emblem, wherein each of h9 and h10 is less than h7, and wherein h9 may or may not be equal to h10. After molding and cooling of the part, emblem 11 returns to height h11 which is less than h1 and preferably greater than h8. The substrate base adjacent the emblem returns to height h13 which is less than h7 and greater than h9. The substrate base beneath the emblem returns to height h12 which is less than h7 and greater than h10. In another embodiment, emblem 11 does not return to height h11, but rather remains at height h8, FIG. 15, such that the top of emblem 11 is flush with the top of substrate base 22 and not slightly raised thereabove as in FIG. 14.

In each of the embodiments of FIGS. 8-15, emblem 11 is at least partially embedded in substrate base 22 to provide an embedded profile on the first surface (the surface facing the user) of the in-mold decorated component, FIG. 16.

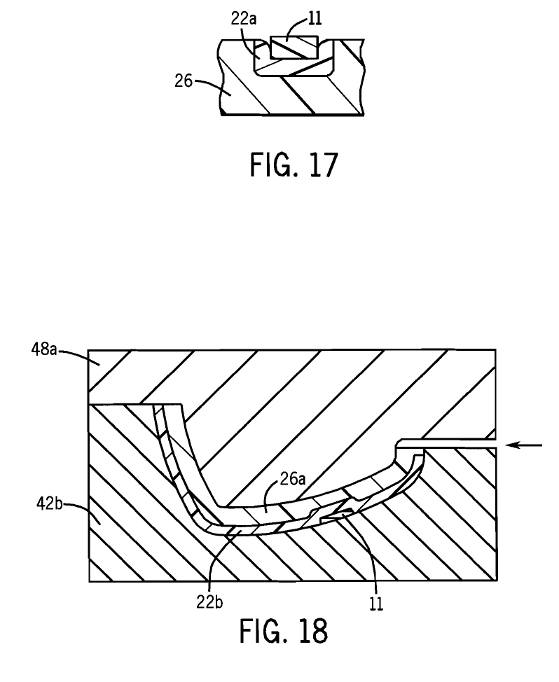

In further embodiments, the substrate base may have a limited lateral extent. Rather than spanning the entire mold cavity as in FIGS. 4-13, a substrate base may be provided only beneath the emblem and along the sides thereof, as shown at substrate base 22a in FIG. 17.

The substrate base and mold surfaces need not be flat and rectilinear, but may have various contours and curves, for example as shown at mold halves 48a and 42b in FIG. 18 for emblem 11 on substrate base 22b and injected molten plastic hardened to formed foundation 26a.

The present system provides a method of making an in-mold decorated component. The method includes providing a three-dimensional elevational emblem 11, supporting the emblem on a substrate base 22 to provide a subcomponent 24, placing the subcomponent in an injection mold, injecting molten plastic against the subcomponent to fuse therewith and form an injection molded part including a formed foundation 26 in-molded to and supporting subcomponent 24, and removing the part from the injection mold to provide the in-mold decorated component. Each of the emblem 11, the substrate base 22, and the formed foundation 26 has first and second oppositely facing surfaces, the first surface facing the user, and the second surface facing oppositely from the first surface. The method includes supporting emblem 11 at the second surface 30 thereof on the first surface 28 of the substrate base 22, and injecting molten plastic against the second surface 32 of the substrate base 22 to fuse therewith such that the first surface 34 of the formed foundation 26 is in-molded to the second surface 32 of the substrate base 22. The method includes bonding the emblem 11 at the second surface 30 thereof to the first surface 28 of the substrate base 22, e.g. by adhesive film 36 or various alternatives such as noted above, prior to the noted step of injecting molten plastic. The method includes in the preferred embodiment at least partially embedding emblem 11 in substrate base 22 during the step of forming the injection molded part, by at least one of: a) compressing the emblem 11; b) forming and bending the substrate base 22 around the emblem 11; and c) compressing the substrate base 22 beneath the emblem 11. In one embodiment, the method involves compressing the emblem 11 during the step of injecting molten plastic. In other embodiment, the method includes additionally or alternatively forming and bending substrate base 22 around emblem 11 during the step of injecting molten plastic. In another embodiment, the method involves additionally or alternatively compressing substrate base 22 beneath emblem 11 during the step of injecting molten plastic. In another embodiment, the method involves both compressing emblem 11 during the step of injecting molten plastic and simultaneously forming and bending substrate base 22 around emblem 11 during the step of injecting molten plastic. In another embodiment, the method involves both compressing emblem 11 during the step of injecting molten plastic and simultaneously compressing substrate base 22 beneath emblem 11 during the step of injecting molten plastic. In another embodiment, the method includes all of: compressing emblem 11 during the step of injecting molten plastic; and simultaneously forming and bending substrate base 22 around emblem 11 during the step of injecting molten plastic; and simultaneously compressing substrate base 22 beneath emblem 11 during the step of injecting molten plastic. The component has a first surface facing the user, and an oppositely facing second surface, and preferably an embedded profile is provided on the first surface of the component, and the method includes forming an embedded profile on the first surface of the component against a mold surface 50 which is non-conforming to the profile such that the profile is independent of mold geometry at mold surface 50, whereby the same mold may be used for differing emblems 11 without having to change molds 48, 42a or use custom molds.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. An in-mold decorated component comprising:
a three-dimensional elevational emblem;
a substrate base supporting said emblem and providing a subcomponent in combination therewith;
a formed foundation in-molded to and supporting said subcomponent.

2. The in-mold decorated component according to claim 1 wherein each of said emblem, said substrate base, and said formed foundation has first and second oppositely facing surfaces, said first surface facing the user, said second surface facing oppositely from said first surface, and wherein:
said first surface of said substrate base supports said second surface of said emblem;
said second surface of said substrate base is in-mold bonded to said first surface of said formed foundation.

3. The in-mold decorated component according to claim 2 comprising a bonding layer bonding said emblem to said substrate base to provide said subcomponent.

4. The in-mold decorated component according to claim 3 wherein said bonding layer is a pressure-sensitive adhesive layer adhesively bonding said emblem to said substrate base.

5. The in-mold decorated component according to claim 3 wherein said bonding layer is a heat-seal adhesive bonding said emblem to said substrate base.

6. The in-mold decorated component according to claim 2 wherein said emblem is sonically welded to said substrate base.

7. The in-mold decorated component according to claim 2 comprising a removable heat-resistive carrier film on said first surface of said emblem, wherein said carrier film is between said first surface of said emblem and a mold surface during in-molding of said formed foundation.

8. The in-mold decorated component according to claim 2 wherein said subcomponent is compressible.

9. The in-mold decorated component according to claim 8 wherein said emblem is compressible and said substrate base is incompressible.

10. The in-mold decorated component according to claim 8 wherein each of said emblem and said substrate base is incompressible.

11. The in-mold decorated component according to claim 8 wherein said formed foundation is rigid.

12. The in-mold decorated component according to claim 2 wherein at least one of said emblem and said substrate base includes a layer of vinyl.

13. The in-mold decorated component according to claim 2 wherein at least one of said emblem and said substrate base includes a layer of leather.

14. The in-mold decorated component according to claim 2 wherein said emblem includes a layer providing a bright metallic appearance.

15. The in-mold decorated component according to claim 14 wherein said layer providing said bright metallic appearance comprises a metallized layer.

16. The in-mold decorated component according to claim 2 wherein said substrate base comprises flexible textured vinyl or cloth.

17. The in-mold decorated component according to claim 2 wherein said emblem is radio frequency formed prior to in-molding of said formed foundation.

18. The in-mold decorated component according to claim 17 wherein said emblem is radio frequency cut.

19. The in-mold decorated component according to claim 2 wherein:
said emblem is at least partially embedded in said substrate base; and
said substrate base is at least one of:
a) formable and bendable around said emblem; and
b) compressible beneath said emblem.

20. The in-mold decorated component according to claim 2 wherein said component has a first surface facing the user, and an oppositely facing second surface, said emblem is at least partially embedded in said substrate base to provide an embedded profile on said first surface of said component and formed against a mold surface which is non-conforming to said profile, the non-conformance of said profile being provided by at least one of:
a) compressibility of said emblem;
b) formability and bendability of said substrate base around said emblem; and
c) compressibility of said substrate base beneath said emblem, such that said profile is independent of mold geometry at said mold surface, whereby the same mold may be used for differing emblems without having to change molds or use custom molds.

21. A method for making an in-mold decorated component, comprising:
providing a three-dimensional elevational emblem;
supporting said emblem on a substrate base to provide a subcomponent;
placing said subcomponent in an injection mold;
injecting molten plastic against said subcomponent to fuse therewith and form an injection molded part including a formed foundation in-molded to and supporting said subcomponent; and
removing said part from said injection mold to provide said in-mold decorated component.

22. The method according to claim 21 wherein each of said emblem, said substrate base, and said formed foundation has first and second oppositely facing surfaces, said first surface facing the user, said second surface facing oppositely from said first surface, and comprising:
supporting said emblem at said second surface thereof on said first surface of said substrate base;
injecting molten plastic against said second surface of said substrate base to fuse therewith such that said first surface of said formed foundation is in-molded to said second surface of said substrate base.

23. The method according to claim 22 comprising bonding said emblem at said second surface thereof to said first surface of said substrate base prior to said step of injecting molten plastic.

24. The method according to claim 21 comprising at least partially embedding said emblem in said substrate base during said step forming said injection molded part, by at least one of:
a) compressing said emblem;
b) forming and bending said substrate base around said emblem; and
c) compressing said substrate base beneath said emblem.

25. The method according to claim 24 comprising compressing said emblem during said step of injecting molten plastic.

26. The method according to claim 24 comprising forming and bending said substrate base around said emblem during said step of injecting molten plastic.

27. The method according to claim 24 comprising compressing said substrate base beneath said emblem during said step of injecting molten plastic.

28. The method according to claim 24 comprising both:
compressing said emblem during said step of injecting molten plastic; and
simultaneously forming and bending said substrate base around said emblem during said step of injecting molten plastic.

29. The method according to claim 24 comprising both:
compressing said emblem during said step of injecting molten plastic; and
simultaneously compressing said substrate base beneath said emblem during said step of injecting molten plastic.

30. The method according to claim 24 comprising:
compressing said emblem during said step of injecting molten plastic; and
simultaneously forming and bending said substrate base around said emblem during said step of injecting molten plastic; and
simultaneously compressing said substrate base beneath said emblem during said step of injecting molten plastic.

31. The method according to claim 24 wherein said component has a first surface facing the user, and an oppositely facing second surface, said embedded profile being on said first surface of said component, and comprising:
forming an embedded profile on said first surface of said component against a mold surface which is non-conforming to said profile such that said profile is independent of mold geometry at said mold surface, whereby the same mold may be used for differing emblems without having to change molds or use custom molds.

32. An in-mold decorated component produced by the method of claim 24.
